(19) United States
(12) Patent Application Publication
(10) Pub. No.: US 2022/0253208 A1
(43) Pub. Date: Aug. 11, 2022

(54) AN INTERACTIVE TOUCH SCREEN PANEL AND METHODS FOR COLLABORATING ON AN INTERACTIVE TOUCH SCREEN PANEL

(71) Applicant: Galaxy Next Generation, Inc., Toccoa, GA (US)

(72) Inventors: Gary D. Lecroy, Toccoa, GA (US); Magen M. McGahee, Lake Park, GA (US)

(21) Appl. No.: 17/624,528

(22) PCT Filed: Jul. 2, 2020
(86) PCT No.: PCT/US2020/040727

§ 371 Date: Jan. 3, 2022

Related U.S. Application Data
(60) Provisional application No. 62/869,836, filed on Jul. 2, 2019.

(51) Int. Cl. G06F 3/04883; G06F 3/04817; G06F 3/04842; G06F 3/04845

(52) U.S. Cl. CPC G06F 3/04883; G06F 3/04817; G06F 2203/04808; G06F 3/04845; G06F 3/04842

(57) ABSTRACT

An interactive touch screen panel (ITSP) is provided and methods performed by the ITSP are provided. The ITSP is configured to perform methods that allow the presenter or instructor to annotate, record, and teach from any input or software on the panel. In addition, the ITSP is configured to execute at least a main application program and a collaboration application program. The collaboration application program is capable of incorporating all devices in the room that are connected to a network to which the ITSP is also connected into a smooth learning environment that allows the user devices to interact and collaborate on the ITSP.

### CROSS-REFERENCE TO RELATED APPLICATIONS

This application is a PCT international application that claims priority to, and the benefit of the filing date of, a U.S. provisional patent application Ser. No. 62/869,836, filed on Jul. 2, 2019, entitled “AN INTERACTIVE TOUCH SCREEN PANEL AND METHODS FOR COLLABORATING ON AN INTERACTIVE TOUCH SCREEN PANEL,” which is incorporated by reference herein in its entirety.

### TECHNICAL FIELD

The present disclosure is generally related to interactive touch screen panels (ITSPs), and more particularly, to an ITSP that is configured to perform methods for collaborating on an ITSP.

### BACKGROUND

ITSPs are commonly used in various environments, including, for example, learning environments such as classrooms. As technology in learning continues to evolve, new challenges are presented. One of the greatest challenges is providing the capability to connect the ITSP with other devices that are present in the learning environment.

A need exists for a way to allow devices that are present in a learning environment to connect with and to interact with an ITSP to facilitate collaboration in the learning environment.

### BRIEF DESCRIPTION OF THE DRAWINGS

Many aspects of the inventive principles and concepts can be better understood with reference to the following drawings. The components in the drawings are not necessarily to scale, emphasis instead being placed upon clearly illustrating the inventive principles and concepts. Moreover, in the drawings, like reference numerals designate corresponding parts throughout the several views.

FIG. 1 is an example of a screen that is displayed on the ITSP when the user launches a main application in accordance with a representative embodiment.

FIG. 2 is an example of a screen that is displayed on the ITSP when the user launches a pin tool application shown in FIG. 1 to launch the drop-down menu shown in FIG. 2 for choice of color, size adjustment (line thickness) and two eraser options

FIG. 3 is a screen shot of a screen that is displayed on the ITSP when the user launches the highlighter icon shown in FIG. 1 and duplicated in FIG. 3 to cause the highlighter tool application to launch a drop-down menu choice for color, size adjustment (line thickness) and two eraser options, as shown in FIG. 3.

FIG. 4 is a screen shot of a screen that is displayed on the ITSP when the user launches the capture tool application by a single-finger touch on the camera icon shown in FIG. 1 and duplicated in FIG. 4

FIG. 5 is a screen shot of a screen that is displayed on the ITSP when the user launches a whiteboard tool application by a single-finger touch by the user on the whiteboard icon shown in FIG. 1 and duplicated in FIG. 5 to cause the whiteboard tool application to launch.

FIG. 6 is a screen shot of a screen that is displayed on the ITSP when the user selects the new-page icon in the second-layer bubble shown in FIG. 5.

FIG. 7 is a screen shot of a screen that is displayed on the ITSP when the user launches the collaboration application by a single-finger touch by the user on an icon of the main bubble shown in FIG. 1 and duplicated in FIG. 7 to cause the collaboration application to launch.

FIG. 8 is a screen shot showing what happens when each option of the three-bubble option shown in FIG. 7 is selected.

FIG. 9 is a screen shot showing a screen of the ITSP that is populated with student's identities or student device identities when the instructor selects the “select your group” bubble shown in FIG. 8 and then chooses the group of devices that are able to be shared; this population will be listed by device or student name and is set up in the admin portal.

FIG. 10 is a screen shot showing the selection that a student can make to download the student-device portion of the collaboration application to the student device.

FIG. 11 is a screen shot showing the groups or classes that the student is assigned to that populate the screen for the student to choose from when the student logs in to the network on a student device that is running the student-device collaboration application.

FIG. 12 is a screen shot that is displayed on the student device if the student is not already assigned to a specific group requiring the student to enter the group ID, the passcode, and their username in order to present as part of that group.

FIG. 13 is a screen shot of an admin portal of the collaboration application that gives users access to set up entire schools and campuses via the admin portal; the admin portal allows an administrator to set up all the devices in the system and group them into the groups associated with the instructor; the admin portal allows information to be pulled directly in to the ITSP from, for example, Google Classroom, Office 365 accounts, or Active Directory accounts that are already defined as groups and users.

FIG. 14 is a screen shot of the admin portal that can be used by a super-admin after the initial set-up has been completed to allow the super-admin to edit the groups, users, or devices and panel settings that can collaborate; from here, the admin can add presenters or instructors to groups, remove them from groups, create new groups, assign roles to the application and manage the connection that is seen between the ITSP and the student devices in each group; this web portal preferably will also be the area for application downloads, application updates, firmware updates and new bubble install packages.

FIG. 15 is a pictorial diagram of an interactive learning environment in which an ITSP is in communication with a plurality of student devices via a wireless network.

FIG. 16 illustrates a block diagram of the ITSP shown in FIG. 15 in accordance with a representative embodiment.

FIG. 17 is a flow diagram depicting the method performed by the ITSP in accordance with a representative embodiment for collaborating on ITSP.

### DETAILED DESCRIPTION

In accordance with inventive principles and concepts described herein, the ITSP is configured to perform methods that allow the presenter or instructor to annotate, record, and teach from any input or software on the panel. In addition, the ITSP is configured to execute a collaboration application software and/or firmware program that is capable of incorporating all devices in the room that are connected to a network into a smooth learning environment that allows the devices to interact and collaborate on the ITSP. An exemplary or representative embodiment of the methods that are performed by the ITSP will now be described with reference to the figures.

Prior to describing the collaboration application, a main application program (hereinafter referred to as the “main application”) from which the collaboration application program (hereinafter referred to as the “collaboration application”) can be launched will be described.

In the following detailed description, for purposes of explanation and not limitation, exemplary, or representative, embodiments disclosing specific details are set forth in order to provide a thorough understanding of an embodiment according to the present teachings. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

It is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

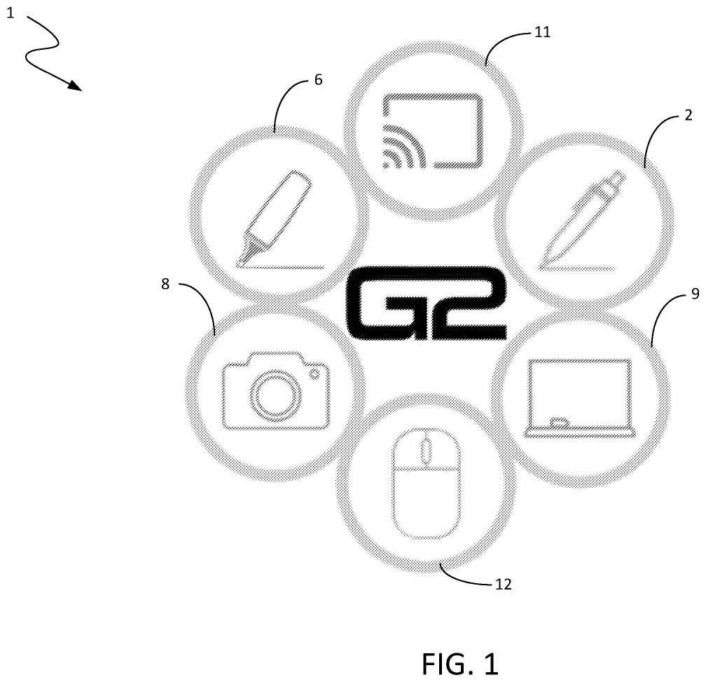

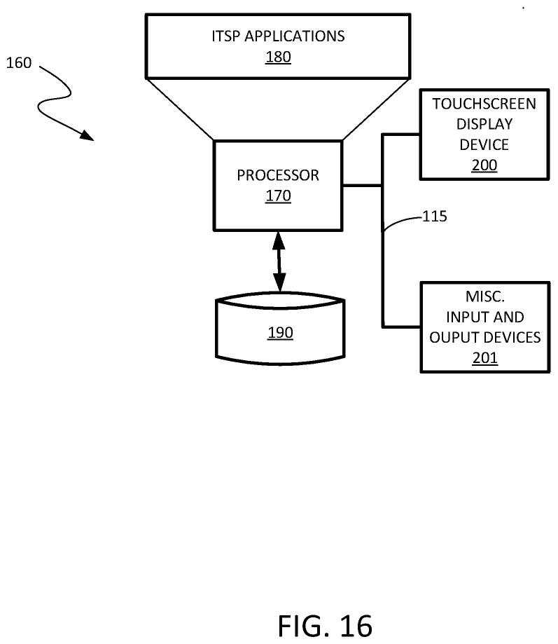

FIG. 1 is a screen 1 of a that is displayed on the ITSP (not shown) when the user launches the main application. An example of the ITSP is described below with reference to FIG. 16. In accordance with an embodiment, the main application is launched by the user pressing the screen of the ITSP with a two-finger touch. To perform the two-finger touch, the user places two fingers side by side in contact with one another and touches the screen such that both fingers are in contact with the screen substantially simultaneously. Computer code executed by a processor of the ITSP recognizes the two-finger touch as a command to launch the main application and causes the “main bubble” screen shown in FIG. 1 to be displayed on the ITSP. In accordance with an embodiment, the main bubble screen 1 and any subsequently displayed bubble screen can be closed with a single-finger double click by the user no matter which application is running and which bubble screen is currently displayed on the display screen of the ITSP. A single-finger double click refers to the use tapping the screen twice in a row with one finger. Examples of the computer code and the processor that executes the computer code are described below with reference to FIG. 16.

A single-finger touch (i.e., tapping the screen once with a finger) by the user on the center G2 of the main bubble screen 1 will take the user to the previous application bubble. Touching and holding the center G2 will allow the user to move the bubble to any other spot on the screen. Thus, the computer code executed by the processor (FIG. 16) is designed to recognize and distinguish between these different finger-touch actions by the user.

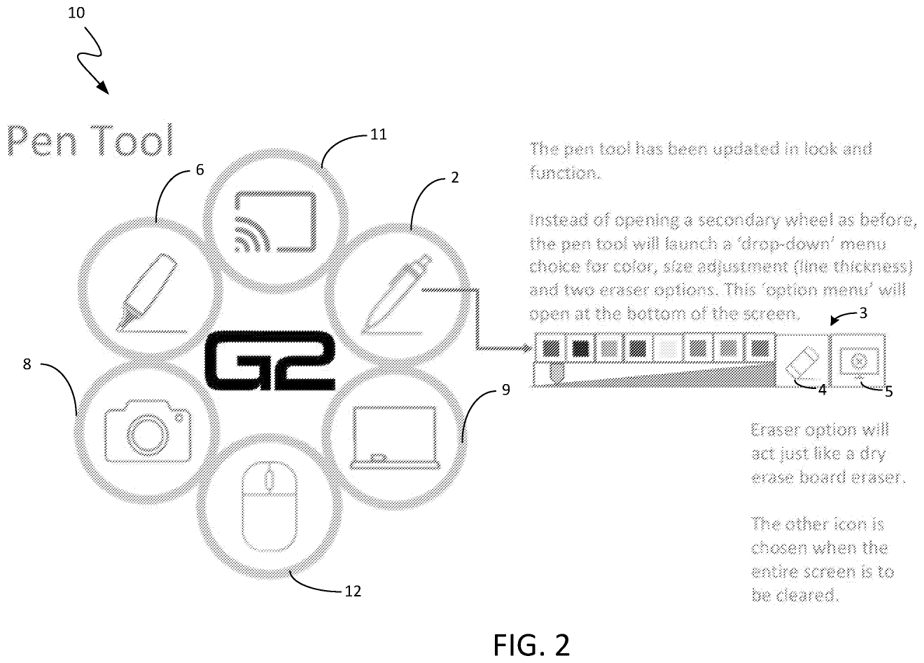

FIG. 2 is an example of a screen 10 that is displayed on the ITSP when the user launches a pin tool application. In accordance with an embodiment, a single-finger touch by the user on the pin icon 2 of the bubble screen 1 shown in FIG. 1, which is also duplicated in FIG. 2, launches the pin tool application, which causes a drop-down option menu 3 to be displayed in the screen 10. The drop-down option menu 3 provides choices for color, size adjustment (line thickness) and two eraser options, as shown in FIG. 2. This option menu 3 preferably opens at the bottom of the screen 2. The eraser icon 4 in the drop-down menu operates like a dry erase board eraser. The icon 5 to the right of the eraser icon 4 in the drop-down option menu 3 when looking at the screen 2, when selected, clears the entire display screen.

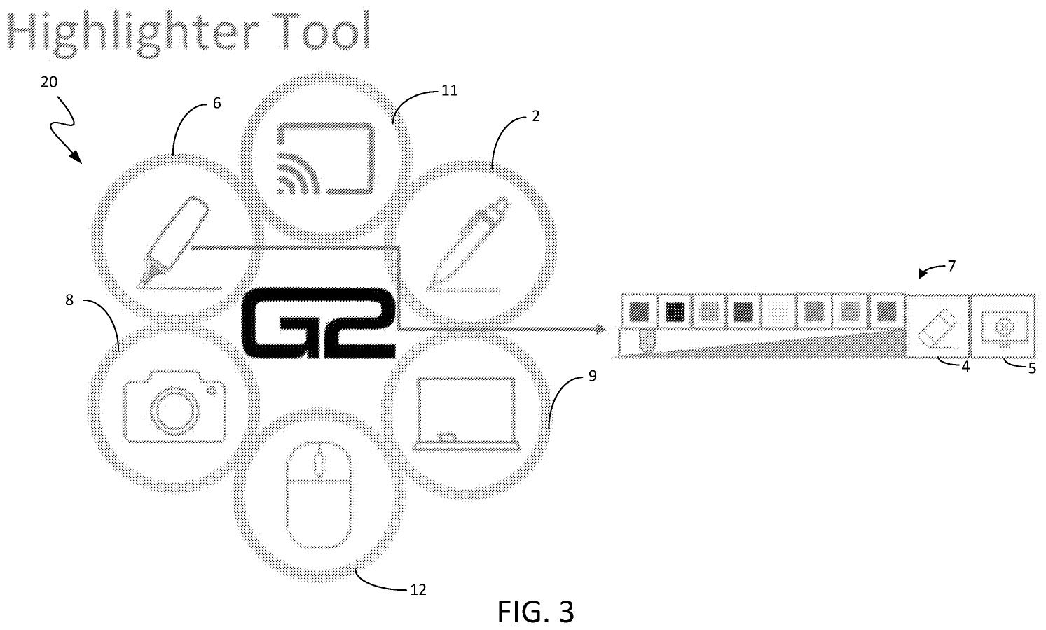

FIG. 3 is an example of a screen 20 that is displayed on the ITSP when the user launches a highlighter tool application. In accordance with an embodiment, a single-finger touch by the user on the highlighter icon 6 of the main bubble screen 1 shown in FIG. 1 and duplicated in FIG. 3 as screen 20 launches the highlighter tool application, which causes the drop-down menu 7 that provides a choice for color, size adjustment (line thickness) and two eraser options, as shown in FIG. 3. In accordance with this embodiment, the drop-down menu 7 is identical to the drop-down menu 3 shown in FIG. 2 and provides identical functions and operations.

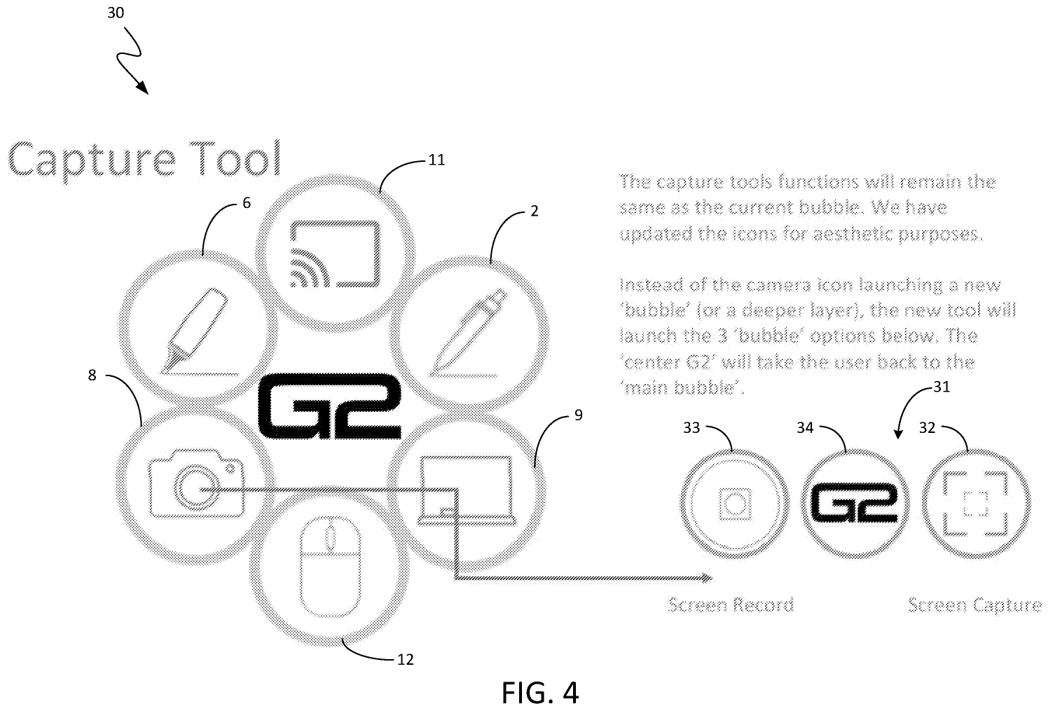

FIG. 4 is an example of a screen 30 that is displayed on the ITSP when the user launches a capture tool application. In accordance with an embodiment, a single-finger touch by the user on the camera icon 8 of the screen 30 shown in FIG. 4 launches the capture tool application, which causes a three-bubble option 31 to be displayed on the ITSP, as shown in FIG. 4. One bubble option 32 is a screen-capture option that, when selected by the user, causes a screen shot of the contents being displayed on the ITSP to be recorded in memory. One bubble option 33 is a screen-record option that, when selected by the user with a single-finger touch, causes the ITSP to begin recording the contents displayed on the ITSP in memory and to continue recording until the user re-selects the screen-record bubble option 33 via a single-finger touch. The bubble option 34 labeled “G2”, when selected by the user with a single-finger touch, returns the display to the main bubble screen 1 shown in FIG. 1.

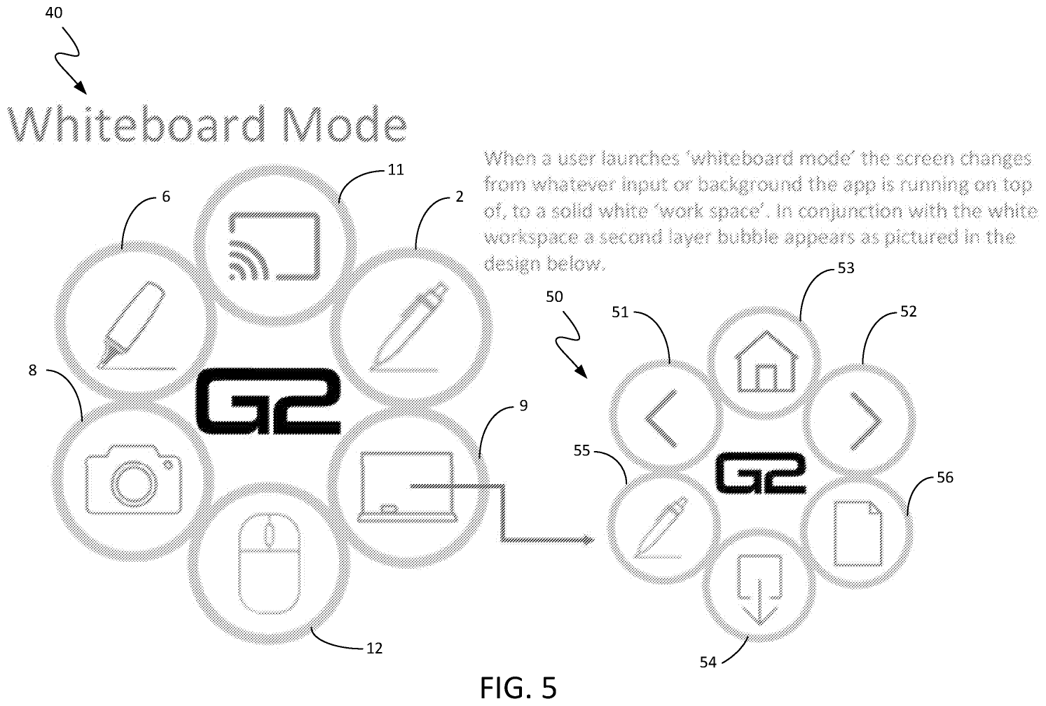

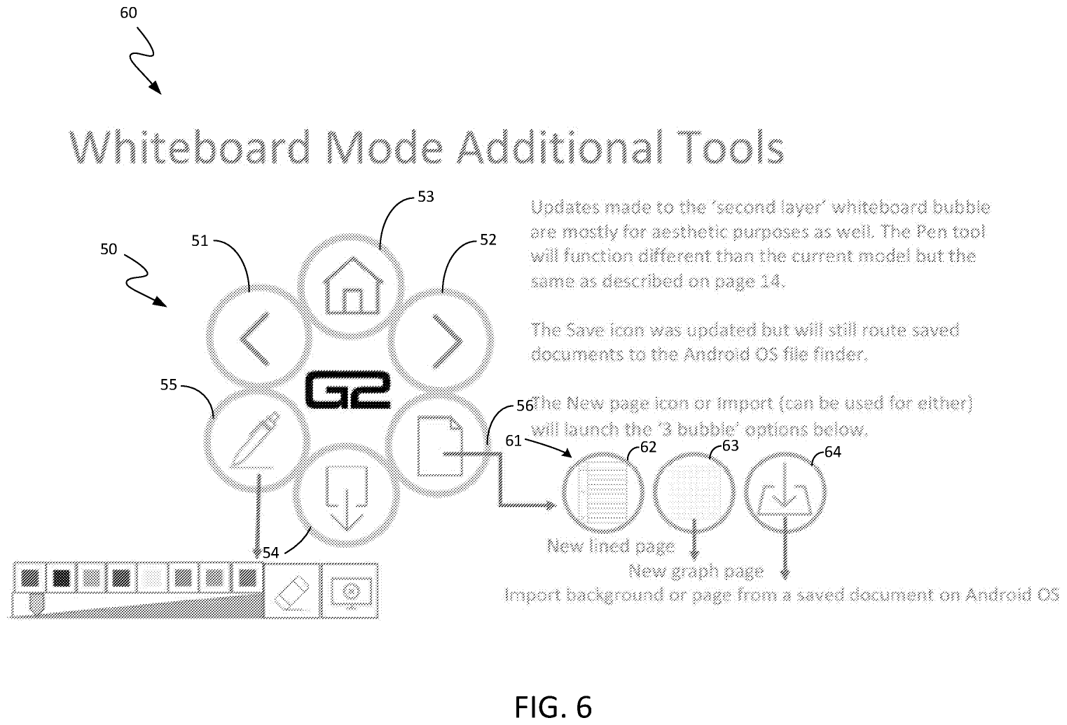

FIG. 5 is an example of a screen 40 that is displayed on the ITSP when the user launches a whiteboard tool application. In accordance with an embodiment, a single-finger touch by the user on the whiteboard icon 9 launches the whiteboard tool application. When the whiteboard tool application is launched, the ITSP enters a whiteboard mode during which the screen changes from whatever input or background the application is running on top of at the current time to a solid white workspace background. In conjunction with the white workspace background being displayed, a second-layer bubble 50 appears, as shown in FIG. 5. The second-layer bubble 50 includes a page-back icon 51 for paging back to the previous screen, a page-forward icon 52 for paging forward to the next screen, a home icon 53 for returning to the screen from which the main application was launched, a download icon 54 that allows the user to download or upload the current screen to a desired location, a pen icon 55 that operates in the manner described above with reference to FIG. 2, and a new-page icon 56, which will now be described with reference to FIG. 6.

FIG. 6 is an example of a screen 60 that is displayed on the ITSP when the user selects the new-page icon 56 in the second-layer bubble 50 shown in FIG. 5. Selecting the new-page icon 56, or import icon (icon 56 can be used for either), will launch the three-bubble option 61 shown in FIG. 6. Selecting a new-lined-page icon 62 causes a new lined page to be displayed, as shown in FIG. 6. Selecting a new-graph-page icon 63 causes a new graph page to be displayed, as shown in FIG. 6. Selecting a download icon 63 allows a background or page to be imported from a saved document on Android OS, as indicated in FIG. 6.

As indicated above, one of the greatest challenges in an interactive learning environment is providing the capability of connecting the ITSP with other devices that are present in the learning environment. The collaboration application meets this challenge by allowing devices that are present in the learning environment to connect with and to interact with the ITSP to facilitate collaboration in the learning environment, as will now be described.

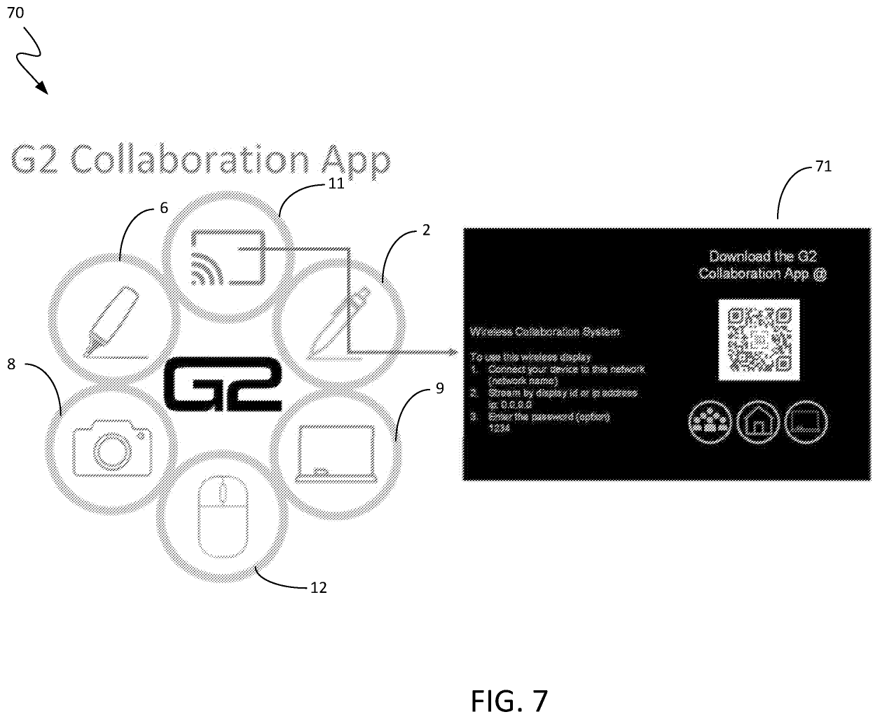

FIG. 7 is an example of a screen 70 that is displayed on the ITSP when the user launches the collaboration application. In accordance with an embodiment, a single-finger touch by the user on the icon 11 of the main bubble screen 1 shown in FIG. 1 and duplicated in FIG. 7 causes the collaboration application to launch. In accordance with an embodiment, when the collaboration application is launched, the ITSP launches a separate screen 71 and removes the main bubble from “floatation.” The new screen 71 preferably launches as a different input of the ITSP. This input preferably is an internal connectivity router with both HDMI and USB connections to transfer the audio and video, as well as touch, when other devices are wirelessly streaming to the ITSP. When the collaboration application is first launched, the screen 71 appears as shown in FIG. 7 with instructions for the users of other devices in the learning environment to connect to the router, and instructions for downloading a desktop collaboration application. For clarity, these other users in the environment will be referred to as students to differentiate them from the user of the ITSP. For clarity, the user of the ITSP will be referred to hereinafter as the instructor. It will be understood that the inventive principles and concepts are not limited to an instructor/student learning environment.

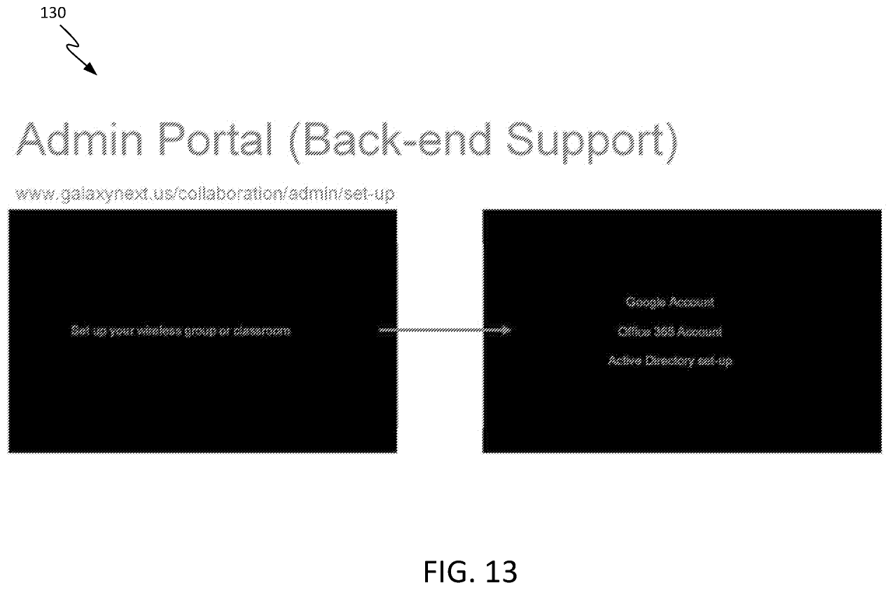

From this screen 71, each student is able to follow the instructions displayed to connect their device (e.g., iOS, Android, Chrome, or Windows device) to the wireless connection of the internal router, or to the existing network to which the ITSP is connected. This screen 71 preferably includes a QR code for quick access to the design and information in FIG. 13, as will be discussed below in more detail, as quick access to the three-bubble option shown in the screen 71 shown in FIG. 7.

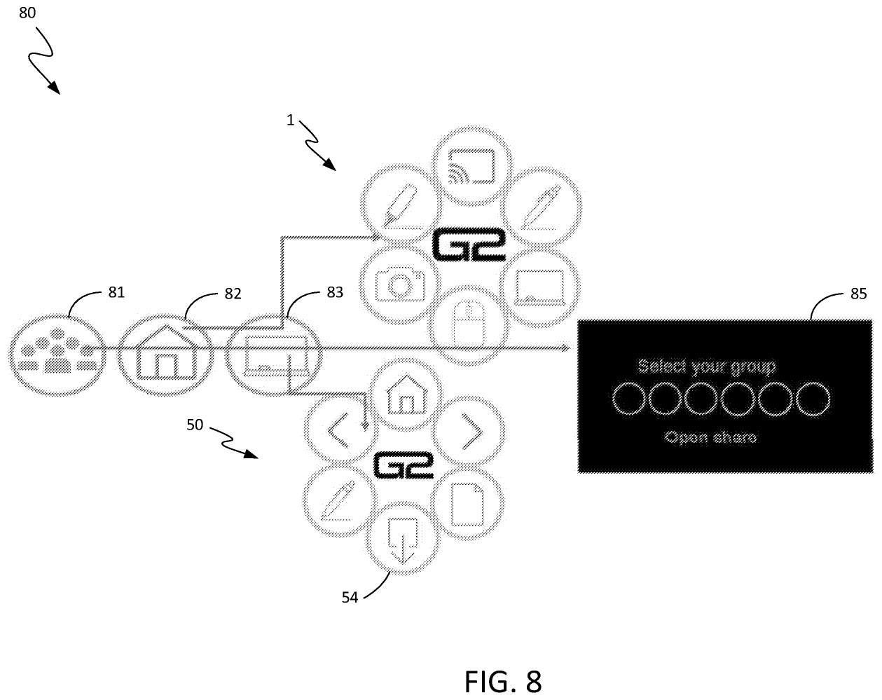

FIG. 8 is an example of a screen 80 showing what happens when each option of the three-bubble option displayed in the screen 71 shown in FIG. 7 is selected. Selection of the leftmost bubble 81 of the three-bubble option (class or group button) launches the “select your group” screen, or page, 85 shown in FIG. 8. From this page 85, the instructor is allowed to choose which group of devices are able to share the ITSP (this is assigned in the admin portal by device and by group, as discussed below in more detail). This page 85 also gives the open share option, which can be chosen when no management of the devices is needed. Open share can be used with all open sharing applications, e.g., Mirror cast, Airplay, Chromecast, etc.

Selection of the middle, or home, bubble 82 of the three-bubble option exits the collaboration application and takes the ITSP back to the main bubble screen 1 shown in FIG. 1 and duplicated in FIG. 8. Selection of the rightmost bubble 83 of the three-bubble option, which is the whiteboard icon 50 shown in FIGS. 5 and 6 launches the second-layer bubble 50 described above with reference to FIGS. 5 and 6.

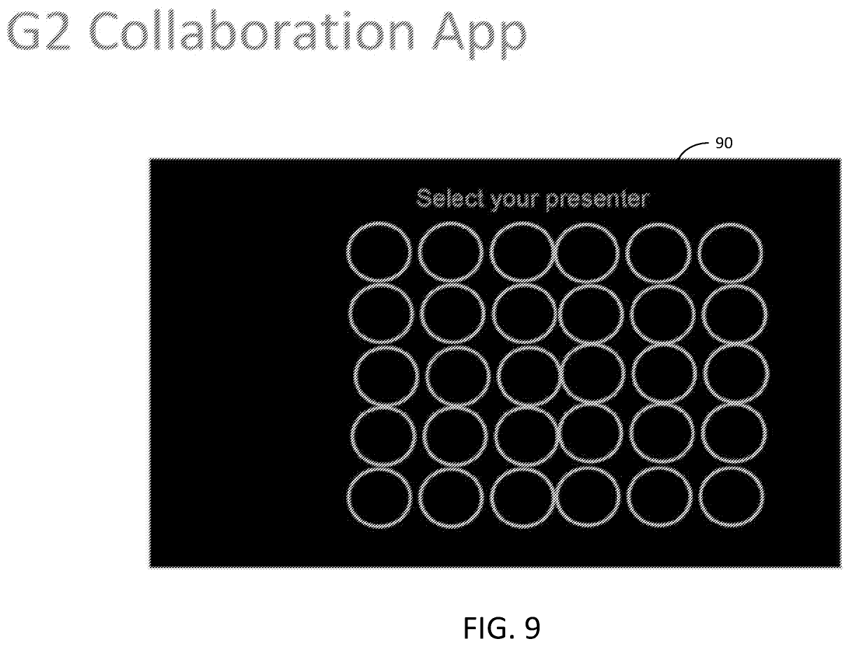

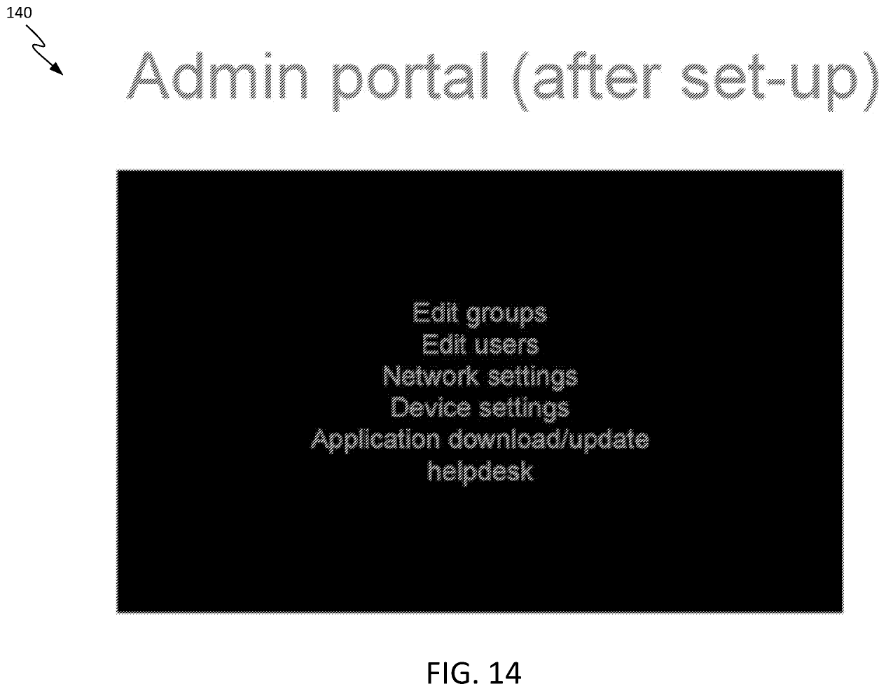

After the “select your group” screen 85 shown in FIG. 8 has been launched and the instructor has chosen which group of devices are able to share the ITSP, then the students' devices that are assigned to that group will populate on the screen 90, as shown in FIG. 9. This population will be listed by device and/or student name and is set up in the admin portal that is discussed below with reference to FIGS. 13 and 14.

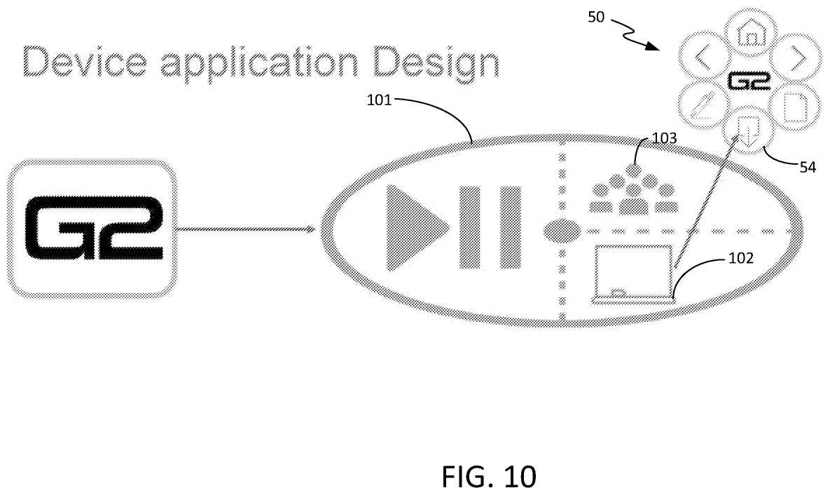

If the student device does not already have a copy of the student-device portion of the collaboration application, the student-device portion of the collaboration application can be downloaded on the student device to allow it to be used in conjunction with the ITSP running the ITSP portion of the collaboration application. When the rightmost bubble 83 of the three-bubble option shown in FIG. 8 is selected by the student, the student then selects the download icon 54 of the second-layer bubble 50, as shown in FIGS. 8 and 10. This causes the student-device collaboration application to be downloaded to the student device. This icon can be launched from a mobile device or a desktop/laptop/notebook device and preferably is the same design for all operating system (OS) platforms.

Once the student follows the instructions on connecting as outlined in the screen 71 shown in FIG. 7, they can launch the student-device collaboration application on their device and use the play/pause icon 101 shown in FIG. 10 to play (wirelessly present from the student device) and pause (stop wirelessly presenting from the student device). The whiteboard icon 102 shown in FIG. 10 allows the student to launch the whiteboard mode from his or her device. The group icon 103 shown in FIG. 10 allows the student to enter the collaboration settings (again, laid out in FIG. 7).

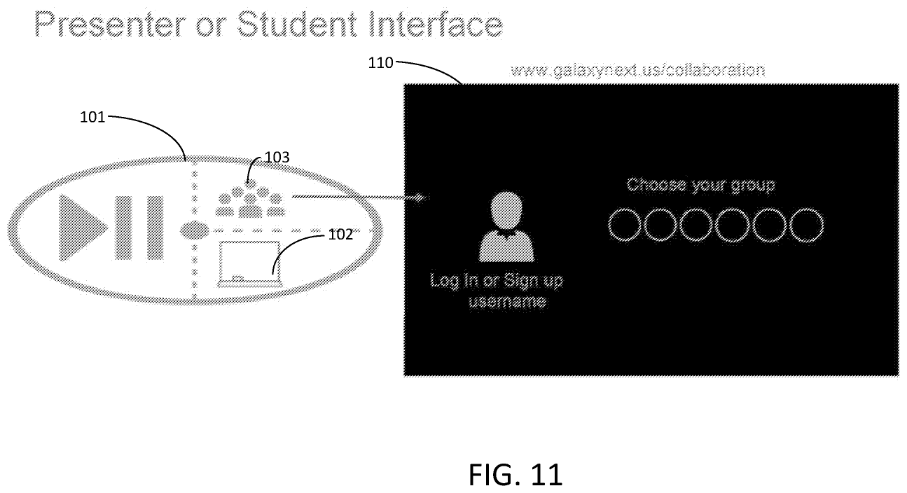

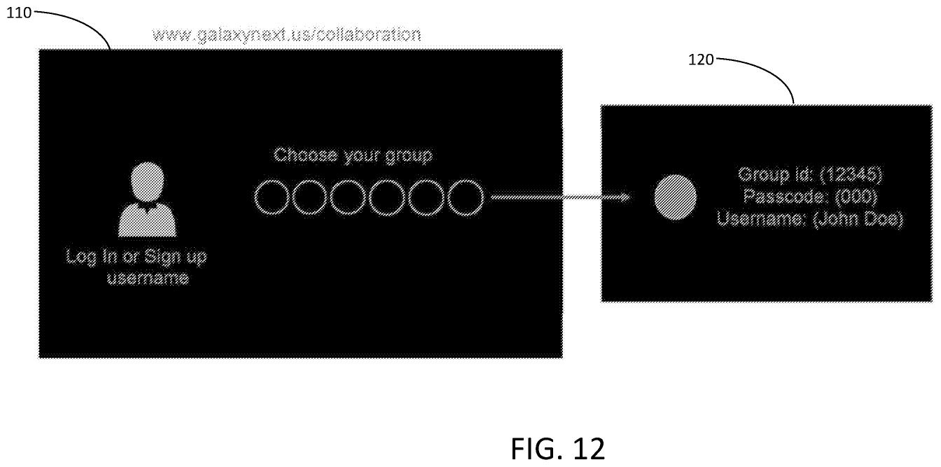

When the instructor or a student enters the learning environment and launches their desktop or mobile portion of the collaboration application, the user will be directed to sign in. Once they are signed in, the groups or classes that they are assigned to will populate for them to choose from, as shown in the screen shot 110 of FIG. 11. If the user is not already assigned to that specific group, then preferably the user would be required to enter the group ID, the passcode, and their username, as shown in the screen shot 120 shown in FIG. 12, in order to present as part of that group.

In order to use the collaboration features of the ITSP to their fullest potential, the user is given access to set up entire schools and campuses via the admin portal, a screen shot 130 of which is shown in FIG. 13. The admin portal allows an administrator to set up all of the devices in the system and group them into the groups associated with the instructor. This will preferably be in “set-up wizard” format and will allow for the information to be pulled directly into the system from predefined groups, examples of which include Google Classroom accounts, Office 365 accounts, or Active Directory accounts, for example, that are already defined as groups and users.

After the initial set-up has been completed, a super-administrator has the log in capability to edit the groups, users, or devices and panel settings, as shown in the screen shot 140 of FIG. 14. From here, the admin can add presenters or instructors to groups, remove them from groups, create new groups, assign roles to the application and manage the connection that is seen between the ITSP and the devices in each group. This web portal preferably will also be the area for the administrator or super-administrator to perform application downloads, application updates, firmware updates and new bubble install packages.

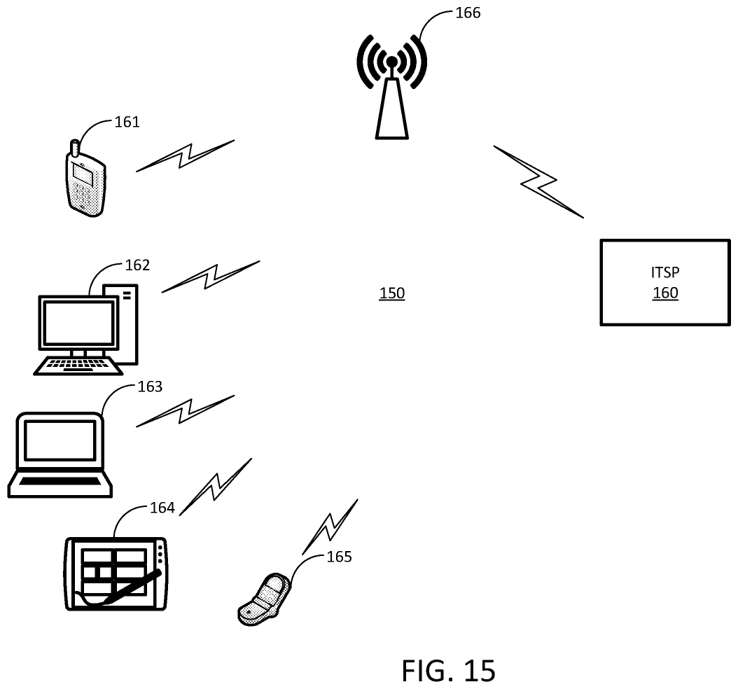

FIG. 15 is a pictorial diagram of an interactive learning environment 150 in which an ITSP 160 is in communication with a plurality of student devices 161-165 via a wireless network 166. It should be noted that the ITSP 110 could be interconnected to one or more of the student devices 101-105 via a wired network such as an Ethernet network, for example, instead of via a wireless connection. For demonstrative purposes, it will be assumed that the student devices 161-165 are wireless devices capable of connecting to the wireless network 166.

With reference to FIG. 8, the instructor launches the collaboration application on the ITSP 160 and the students follow the instructions shown in screen 71 of FIG. 7 to connect the student devices 161-165 to the wireless network 166. If a student does not already have the student-device collaboration application on their device, the student performs the steps described above to download the student-device collaboration application to the student device. Once the student-device application programs are running on the student devices 161-165, the students are able to present on the ITSP 160 from their respective student devices 161-165 in order to collaborate with one another and with the instructor. The student devices 161-165 display the same screens and tools in the student-device collaboration application that are described above with reference to FIGS. 1-6 when the student device is in the play mode described above with reference to FIG. 10.

FIG. 16 illustrates a block diagram of the ITSP 160 shown in FIG. 15 in accordance with a representative embodiment. A processor 170 of the ITSP 160 is configured to execute one or more ITSP applications 180, including the main application and the collaboration application described above with reference to FIGS. 1-15, which of which can be combined into a single application. As described above, the main application and the collaboration application each launch multiple other applications or routines in response to touch commands and/or other actions taken by the user. These other applications or routines are also part of the ITSP applications 180. A memory device 190 of the ITSP 160 is a non-transitory computer-readable medium that stores computer instructions comprising the ITSP applications 180 and may also store data used and/or generated by the processor 170. A touchscreen display device 200 of the ITSP 160 is in communication with the processor 170 via a wired or wireless link 201, which is typically a wired bus. The processor 170 processes touch commands entered by the user on the touchscreen display device 200 and causes the corresponding screens to be displayed on the touchscreen display device 200 in response to the touch commands entered by the user, as described above with reference to FIGS. 1-15. The ITSP 160 may include other miscellaneous input and/or output devices, such as a keyboard, a microphone, a speaker, etc.

The student devices 161-165 can have a configuration that is similar or identical to the configuration shown in FIG. 16, although the processor of the student device executes the student-device collaboration application, but typically is not configured to execute the ITSP main application or the ITSP collaboration application. Therefore, in the interest of brevity, the configurations of the student devices are not described herein.

The applications 180 comprise one or more algorithms performed by the processor 170. Many variations may be made to the algorithms described herein. Also, while various embodiments of the applications 180 have been described herein for carrying out specific tasks, other algorithms not specifically mentioned herein may be performed by the processor 170. For any or all portions of algorithms 180 that are implemented in software and/or firmware being executed by processor 170, the corresponding computer instructions can be stored in a non-transitory memory device, such as the memory device 190. For any component discussed herein that is implemented in the form of software or firmware, any one of a number of programming languages may be employed such as, for example, C, C++, C#, Objective C, Java®, JavaScript®, Perl, PHP, Visual Basic®, Python®, Ruby, Flash®, or other programming languages.

The memory device 190 can include, for example, random access memory (RAM), read-only memory (ROM), a hard drive, a solid-state drive, a USB flash drive, a memory card, an optical disc such as compact disc (CD) or digital versatile disc (DVD), a floppy disk, a magnetic tape, static random access memory (SRAM), dynamic random access memory (DRAM), magnetic random access memory (MRAM), a programmable read-only memory (PROM), an erasable programmable read-only memory (EPROM), an electrically erasable programmable read-only memory (EEPROM), or other like memory device.

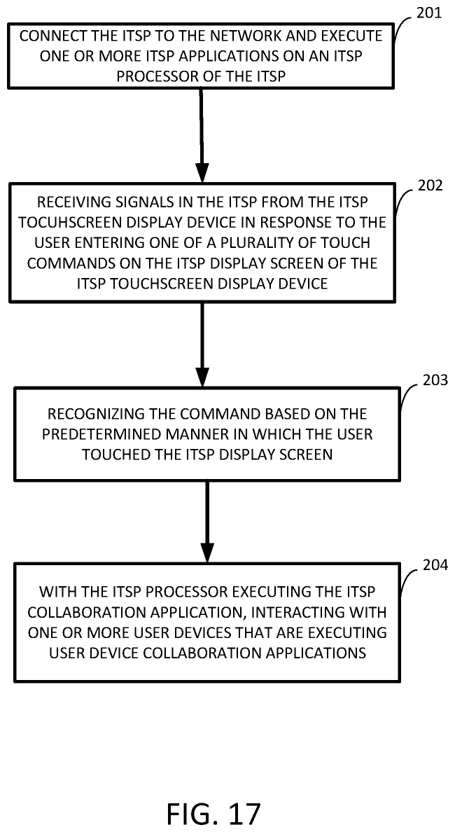

FIG. 17 is a flow diagram depicting the method performed by the ITSP in accordance with a representative embodiment for collaborating on ITSP. Block 201 represents connecting the ITSP to a network and executing one or more ITSP applications on the ITSP. Block 202 represents the step of the ITSP receiving signals from the ITSP touchscreen display device in response to a user entering one of a plurality of commands to the ITSP by touching an ITSP display screen of the ITSP touchscreen display device in a predetermined manner. Bock 203 represents the ITSP recognizing one of a plurality of commands based on the predetermined manner in which the user touched the ITSP display screen.

At least one of the ITSP applications being executed by the ITSP processor is the ITSP collaboration application. One or more user devices are connected to the ITSP via the network, and at least one of the user devices has a user device processor configured to execute a user device collaboration application. Block 204 represents the ITSP executing the ITSP collaboration application interacting with the user device processor executing the user device collaboration application to allow the user of the ITSP to collaborate with the user of the user device on the ITSP display screen.

It should be noted that the method depicted in FIG. 17 can include many additional steps that are not explicitly shown in FIG. 17, such as the ITSP processor launching various applications in response to commands entered by the user of the ITSP and/or by the users of one or more user devices during collaboration, as described above with reference to FIGS. 1-15.

### Inventive Aspects

The following are various aspects according to the inventive principles and concepts discussed above in the present disclosure. It will be understood by those of skill in the art in view of the present disclosure that the inventive principles and concepts are not limited to these various aspects.

An ITSP is disclosed comprising an ITSP touchscreen display device, an ITSP memory device and an ITSP processor in communication with the touchscreen display device. The ITSP processor is configured to execute one or more ITSP applications. The one or more ITSP applications receive signals from the ITSP touchscreen display device in response to a user entering one of a plurality of commands to the ITSP by touching an ITSP display screen of the ITSP touchscreen display device in a predetermined manner. The one or more ITSP applications recognize the command based on the predetermined manner in which the user touched the ITSP display screen.

In accordance with an embodiment, the one or more ITSP applications allow the user to annotate, record, and present information on the touchscreen display device by using tool applications that are launched by a main application being executed by the ITSP processor when the user touches respective icons displayed on the touchscreen display device.

In accordance with an embodiment, the one or more ITSP applications allow users of other user devices to interact with the ITSP via respective user devices that are connected to the ITSP via a wired or wireless connection. Each user device comprises a processor configured to execute a user device collaboration application designed to interact with said one or more ITSP applications.

In accordance with an embodiment, the ITSP processor launches a main application of the one or more ITSP applications when the user performs a two-finger touch on the display screen of the ITSP touchscreen display device by placing two fingers side by side in contact with one another and touching the display screen such that both fingers are in contact with the display substantially simultaneously. The ITSP processor recognizes the two-finger touch on the display screen as a command to launch the main application, which causes a main bubble screen to be displayed on the display screen.

In accordance with an embodiment, the main bubble screen is closed with a single-finger double click by the user on the display screen.

In accordance with an embodiment, the main bubble screen includes at least a pin tool icon, a highlighter tool icon, a capture tool icon, a whiteboard tool icon, and a collaboration tool icon, each of which can be selected via a single-finger touch by the user on the display screen on the respective icon. A selection of the respective icon by the user causes the ITSP to launch a respective tool application program that allows the user to interact with the ITSP via the respective tool application program.

In accordance with an embodiment, selection of the pin tool icon by the user with a single-finger touch of the pin tool icon by the user causes a pen tool application to launch a drop-down menu with multiple choices for the user to choose from including at least one of choice for color, choice of size adjustment and choice of eraser.

In accordance with an embodiment, selection of the highlighter tool icon with a single-finger touch of the highlighter tool icon by the user causes a highlighter tool application to launch a drop-down menu with multiple choices for the user to choose from including at least one of choice for color, choice of size adjustment and choice of eraser.

In accordance with an embodiment, selection of the capture tool icon with a single-finger touch of the capture tool icon by the user causes a capture tool application to launch a multi-bubble option. One bubble option of the multi-bubble option is a screen-capture option that, when selected by the user, causes a screen shot of the contents being displayed on the display screen to be recorded in the memory device. One bubble option of the multi-bubble option is a screen-record option that, when selected by the user, causes the ITSP processor to begin recording the contents displayed on the display screen in the ITSP memory device and to continue recording until the user re-selects the screen-record bubble option. One bubble option of the multi-bubble option, when selected by the user, causes the main bubble screen to be displayed in the display screen.

In accordance with an embodiment, selection of the whiteboard tool icon with a single-finger touch of the whiteboard tool icon by the user causes a whiteboard tool application to launch and the ITSP to enter a whiteboard mode during which the display screen changes from whatever input or background is currently displayed to a solid white workspace background having a second-layer bubble displayed thereon. The second-layer bubble includes at least one of a page-backward icon for paging back to a previously-displayed screen, a page-forward icon for paging forward to a next screen to be displayed, a home icon for returning to a screen from which the main application was launched, a download icon that allows the user to download or upload the currently-displayed screen to a desired location, a pen tool application icon, and a new-page icon.

In accordance with an embodiment, selection of the collaboration tool icon with a single-finger touch of the collaboration tool icon by the user causes a collaboration application to launch. The collaboration application is one of the ITSP applications. When the collaboration application launches, the ITSP display screen displays a new screen with instructions for users of user devices to connect to the ITSP via a network. Any of the user devices that have a user device collaboration application installed thereon, once connected to the ITSP via the network, can execute the user device collaboration application to share the ITSP with other user devices that are also connected to the ITSP via the network to enable collaboration on the ITSP with the users of the other user devices.

In accordance with an embodiment, any of the user devices that have not yet installed the user device collaboration application when the new screen is displayed can follow instructions contained on the new screen to download the user device collaboration application. Once the user device collaboration application has been downloaded to the respective user device, the respective user device can execute the user device collaboration application to connect with the ITSP via the network to share the ITSP with other user devices that are also connected to the ITSP via the network and collaborate on the ITSP with the users of the other user devices that are connected to the ITSP via the network.

In accordance with an embodiment, once a user device is connected to the ITSP via the network and is running the user device collaboration application, the user device collaboration application causes the main bubble screen to be displayed on a display device of the respective user device. A single-finger touch by the user of the respective user device on one of the icons of the main bubble screen displayed on the display device of the respective user device causes the respective user device collaboration application to launch a tool application program associated with the icon selected by the user of the respective user device.

In accordance with an embodiment, a method for collaborating on an ITSP comprises:

connecting an ITSP to a network and executing one or more ITSP applications on an ITSP processor of the ITSP;

with the ITSP processor executing one or more ITSP applications, receiving signals from the ITSP touchscreen display device in response to a user entering one of a plurality of commands to the ITSP by touching an ITSP display screen of the ITSP touchscreen display device in a predetermined manner;

with the ITSP processor executing one or more ITSP applications, recognizing the command based on the predetermined manner in which the user touched the ITSP display screen; and

with the ITSP processor executing an ITSP collaboration application, interacting with the user device processor executing the user device collaboration application to allow the user of the ITSP to collaborate with the user of the user device on the ITSP display screen.

In accordance with an embodiment, the method further comprises:

while the ITSP processor is executing one or more ITSP applications, the ITSP processor launches a main application of the one or more ITSP applications when the user performs a two-finger touch on the ITSP display screen of the ITSP touchscreen display device by placing two fingers side by side in contact with one another and touching the display screen such that both fingers are in contact with the display substantially simultaneously. The ITSP processor recognizes the two-finger touch on the display screen as a command to launch the main application, which causes a main bubble screen to be displayed on the display screen.

In accordance with an embodiment of the method, the main bubble screen includes at least a pin tool icon, a highlighter tool icon, a capture tool icon, a whiteboard tool icon, and a collaboration tool icon. Each icon can be selected via a single-finger touch by the user on the display screen on the respective icon, wherein a selection of the respective icon by the user causes the ITSP to launch a respective tool application program that allows the user to interact with the ITSP via the respective tool application program.

In accordance with an embodiment of the method a selection of each of the icons of the main bubble screen is performed by the user of the ITSP touching the icon once with a single finger.

In accordance with an embodiment of the method, when the user device collaboration application is launched, the user device processor displays the main bubble screen on the display device of the user device. In accordance with this embodiment, the method further comprises:

while the ITSP processor is executing the one or more ITSP applications, recognizing when the user of the user device has selected an icon of the main bubble screen displayed on the display device of the user device and causing the ITSP to launch a respective tool application program that allows the user of the user device to interact with the ITSP via the respective tool application program.

In accordance with an embodiment, selection of the collaboration tool icon of the main bubble screen displayed on the ITSP display screen with a single-finger touch of the collaboration tool icon by the user of the ITSP causes the ITSP processor to launch the ITSP collaboration application.

In accordance with an embodiment, when the ITSP collaboration application is launched, a new screen is displayed on the ITSP display screen, the new screen containing instructions that inform the user of the user device how to connect to the ITSP via the network.

In accordance with an embodiment, a computer program is provided for execution by a processor of an ITSP. The computer instructions are embodied on a non-transitory computer-readable medium and comprise:
a main application comprising:
a first set of one or more ITSP applications for receiving signals from an ITSP touchscreen display device of the ITSP in response to a user entering one of a plurality of commands to the ITSP by touching an ITSP display screen of the ITSP touchscreen display device in a predetermined manner;
a second set of instructions for processing the received signals to recognize said one of a plurality of commands based on the predetermined manner in which the user touched the ITSP display screen;
a third set of instructions for displaying at least a first screen having a first set of icons on the ITSP display device in accordance with the recognized command, at least one of the icons being a group icon; and
a fourth set of instructions for receiving signals from the ITSP touchscreen display device of the ITSP in response to the user entering a collaboration command by touching the group icon;

and

an ITSP collaboration application that is launched when the user touches the group icon. The ITSP collaboration application is configured to interact with one or more user device collaboration applications being executed on one or more respective user devices to allow the user of the ITSP and the users of the user devices to collaborate on the ITSP display screen.

It should be emphasized that the above-described embodiments of the present disclosure are merely possible examples of implementations, merely set forth for a clear understanding of the principles of the invention. Many variations and modifications may be made to the above-described embodiments described herein without departing from the inventive principles and concepts. All such modifications and variations are intended to be included herein within the scope of this disclosure and the following claims.

What is claimed is:

1. An interactive touch screen panel (ITSP) comprising:
an ITSP touchscreen display device;
an ITSP memory device; and
an ITSP processor in communication with the touchscreen display device, the processor being configured to execute one or more ITSP applications, said one or more ITSP applications receiving signals from the ITSP touchscreen display device in response to a user entering one of a plurality of commands to the ITSP by touching an ITSP display screen of the ITSP touchscreen display device in a predetermined manner, said one or more ITSP applications recognizing said one of a plurality of commands based on the predetermined manner in which the user touched the ITSP display screen.

2. The ITSP of claim 1, wherein said one or more ITSP applications allow the user to annotate, record, and present information on the touchscreen display device by using tool applications that are launched by a main application of said one or more applications when the user touches respective icons displayed on the touchscreen display device.

3. The ITSP of claim 2, wherein said one or more ITSP applications allow users of other user devices to interact with the ITSP via respective user devices that are connected to the ITSP via a wired or wireless connection, each user device comprising a processor configured to execute a user device collaboration application designed to interact with said one or more ITSP applications.

4. The ITSP of claim 1, wherein said ITSP processor launches a main application of said one or more ITSP applications when the user performs a two-finger touch on the display screen of the ITSP touchscreen display device by placing two fingers side by side in contact with one another and touching the display screen such that both fingers are in contact with the display substantially simultaneously, the ITSP processor recognizing the two-finger touch on the display screen as a command to launch the main application, the main application causing a main bubble screen to be displayed on the display screen.

5. The ITSP of claim 4, wherein the main bubble screen is closed with a single-finger double click by the user on the display screen.

6. The ITSP of claim 4, wherein the main bubble screen includes at least a pin tool icon, a highlighter tool icon, a capture tool icon, a whiteboard tool icon, and a collaboration tool icon, each of which can be selected via a single-finger touch by the user on the display screen on the respective icon, wherein a selection of the respective icon by the user causes the ITSP to launch a respective tool application program that allows the user to interact with the ITSP via the respective tool application program.

7. The ITSP of claim 6, wherein selection of the pin tool icon by the user with a single-finger touch of the pin tool icon by the user causes a pen tool application to launch a drop-down menu with multiple choices for the user to choose from including at least one of choice for color, choice of size adjustment and choice of eraser.

8. The ITSP of claim 6, wherein selection of the highlighter tool icon with a single-finger touch of the highlighter tool icon by the user causes a highlighter tool application to launch a drop-down menu with multiple choices for the user to choose from including at least one of choice for color, choice of size adjustment and choice of eraser.

9. The ITSP of claim 6, wherein selection of the capture tool icon with a single-finger touch of the capture tool icon by the user causes a capture tool application to launch a multi-bubble option, one bubble option of the multi-bubble option being a screen-capture option that, when selected by the user, causes a screen shot of the contents being displayed on the display screen to be recorded in the memory device, one bubble option of the multi-bubble option being a screen-record option that, when selected by the user, causes the ITSP processor to begin recording the contents displayed on the display screen in the ITSP memory device and to continue recording until the user re-selects the screen-record bubble option, one bubble option of the multi-bubble option, when selected by the user, causing the main bubble screen to be displayed in the display screen.

10. The ITSP of claim 6, wherein selection of the whiteboard tool icon with a single-finger touch of the whiteboard tool icon by the user causes a whiteboard tool application to launch and the ITSP to enter a whiteboard mode during which the display screen changes from whatever input or background is currently displayed to a solid white workspace background having a second-layer bubble displayed thereon, the second-layer bubble including at least one of a page-backward icon for paging back to a previously-displayed screen, a page-forward icon for paging forward to a next screen to be displayed, a home icon for returning to a screen from which the main application was launched, a download icon that allows the user to download or upload the currently-displayed screen to a desired location, a pen tool application icon, and a new-page icon.

11. The ITSP of claim 6, wherein selection of the collaboration tool icon with a single-finger touch of the collaboration tool icon by the user causes a collaboration application to launch, the collaboration application being one of said one or more ITSP applications, wherein when the collaboration application launches, the ITSP display screen displays a new screen with instructions for users of user devices to connect to the ITSP via a network, and wherein any of the user devices that have a user device collaboration application installed thereon, once connected to the ITSP via the network, can execute the user device collaboration application to share the ITSP with other user devices that are also connected to the ITSP via the network to collaborate on the ITSP with the users of the other user devices.

12. The ITSP of claim 11, wherein any of the user devices that have not yet installed the user device collaboration application on the respective user device when the new screen is displayed can follow instructions contained on the new screen to download the user device collaboration application, and wherein once the user device collaboration application has been downloaded to the respective user device, the respective user device can execute the user device collaboration application to connect with the ITSP via the network to share the ITSP with other user devices that are also connected to the ITSP via the network and collaborate on the ITSP with the users of the other user devices that are connected to the ITSP via the network.

13. The ITSP of claim 12, wherein once a user device is connected to the ITSP via the network and is running the user device collaboration application, the user device collaboration application causes the main bubble screen to be displayed on a display device of the respective user device, and wherein a single-finger touch by the user of the respective user device on one of the icons of the main bubble screen displayed on the display device of the respective user device causes the respective user device collaboration application to launch a tool application program associated with the icon selected by the user of the respective user device.

14. A method for collaborating on an interactive touch screen panel (ITSP), the method comprising:
connecting an ITSP to a network, the ITSP comprising a ITSP touchscreen display device, an ITSP memory device and an ITSP processor in communication with the touchscreen display device, the ITSP processor being configured to execute one or more ITSP applications;
with the ITSP processor executing said one or more ITSP applications, receiving signals from the ITSP touchscreen display device in response to a user entering one of a plurality of commands to the ITSP by touching an ITSP display screen of the ITSP touchscreen display device in a predetermined manner;
with the ITSP processor executing said one or more ITSP applications, recognizing said one of a plurality of commands based on the predetermined manner in which the user touched the ITSP display screen, at least one of said one or more ITSP applications being executed by the ITSP processor being an ITSP collaboration application, wherein one or more user devices are connected to the ITSP via the network, at least one of the user devices having a user device processor configured to execute a user device collaboration application; and
with the ITSP processor executing the ITSP collaboration application, interacting with the user device processor executing the user device collaboration application to allow the user of the ITSP to collaborate with the user of the user device on the ITSP display screen.

15. The method of claim 14, further comprising:
while the ITSP processor is executing said one or more ITSP applications, the ITSP processor launching a main application of said one or more ITSP applications when the user performs a two-finger touch on the ITSP display screen of the ITSP touchscreen display device by placing two fingers side by side in contact with one another and touching the display screen such that both fingers are in contact with the display substantially simultaneously, the ITSP processor recognizing the two-finger touch on the display screen as a command to launch the main application, the main application causing a main bubble screen to be displayed on the display screen.

16. The method of claim 15, wherein the main bubble screen includes at least a pin tool icon, a highlighter tool icon, a capture tool icon, a whiteboard tool icon, and a collaboration tool icon, wherein each icon can be selected via a single-finger touch by the user on the display screen on the respective icon, wherein a selection of the respective icon by the user causes the ITSP to launch a respective tool application program that allows the user to interact with the ITSP via the respective tool application program.

17. The method of claim 16, wherein a selection of each of the icons of the main bubble screen is performed by the user of the ITSP touching the icon once with a single finger.

18. The method of claim 17, wherein when the user device collaboration application is launched, the user device processor displays the main bubble screen on the display device of the user device, the main bubble screen displayed on the display device of the user device, the method further comprising:
while said ITSP processor is executing said one or more ITSP applications, recognizing when the user of the user device has selected an icon of the main bubble screen displayed on the display device of the user device and causing the ITSP to launch a respective tool application program that allows the user of the user device to interact with the ITSP via the respective tool application program.

19. The method of claim 18, wherein selection of the collaboration tool icon of the main bubble screen displayed on the ITSP display screen with a single-finger touch of the collaboration tool icon by the user of the ITSP causes the ITSP processor to launch the ITSP collaboration application.

20. The method of claim 19, wherein when the ITSP collaboration application is launched, a new screen is displayed on the ITSP display screen, the new screen containing instructions that inform the user of the user device how to connect to the ITSP via the network.

21. A computer program for execution by a processor of an interactive touchscreen panel (ITSP), the computer instructions being embodied on a non-transitory computer-readable medium, the computer instructions comprising:
a main application comprising:
a first set of one or more ITSP applications for receiving signals from an ITSP touchscreen display device of the ITSP in response to a user entering one of a plurality of commands to the ITSP by touching an ITSP display screen of the ITSP touchscreen display device in a predetermined manner;
a second set of instructions for processing the received signals to recognize said one of a plurality of commands based on the predetermined manner in which the user touched the ITSP display screen;
a third set of instructions for displaying at least a first screen having a first set of icons on the ITSP display device in accordance with the recognized command, at least one of the icons being a group icon;
a fourth set of instructions for receiving signals from the ITSP touchscreen display device of the ITSP in response to the user entering a collaboration command by touching the group icon;
an ITSP collaboration application that is launched when the user touches the group icon, the ITSP collaboration application being configured to interact with one or more user device collaboration applications being executed on one or more respective user devices to allow the user of the ITSP and the users of said one or more user devices to collaborate on the ITSP display screen.
